(19) United States
(12) Patent Application Publication
(10) Pub. No.: US 2026/0205279 A1
(43) Pub. Date: Jul. 16, 2026

(54) Bootstrapping Secure Trust Using Time-Bound Certificates

(71) Applicant: Syniverse Technologies, LLC, Tampa, FL (US)

(72) Inventors: Chris Wright, Plant City, FL (US); Rajan John Thomas, Sanford, FL (US)

(21) Appl. No.: 19/382,369

(22) Filed: Nov. 7, 2025

Related U.S. Application Data
(63) Continuation of application No. 19/025,375, filed on Jan. 16, 2025, now Pat. No. 12,500,747.

(51) Int. Cl. H04L 9/08; H04L 9/32; H04W 12/72

(52) U.S. Cl. CPC H04L 9/085; H04L 9/3247; H04L 9/3271; H04W 12/72

(57) ABSTRACT

A bootstrapping procedure establishes initial trust between a user device and a cloud multi-factor authentication service before a device-specific shared key is created. The service provisions a time-bounded bootstrap credential that identifies a server public key and a bootstrap key identifier. Inside a trusted execution environment, the device generates a signing key pair, performs a key-establishment operation with the bootstrap public key to derive a bootstrap secret, and submits a signed bootstrap request. The service derives the same secret with the corresponding private key, verifies the signature, and uses the secret to protect early communications, including delivery of an attested blob and carrier challenges. After validation, a device-specific shared key is established for ongoing operation.

### PRIORITY CLAIM

This application claims priority to and is a continuation-in-part of U.S. patent application Ser. No. 19/025,375, filed Jan. 16, 2025, titled “Multi-Factor Authentication with Device and Carrier Validation,” the entire contents of which are incorporated by reference.

### BACKGROUND OF THE INVENTION

### 1. Field of the Invention

The described embodiments relate generally to multi-factor authentication and security protocols for verifying user identity across digital platforms. Specifically, the described embodiments relate to systems and methods for enhancing authentication reliability through the integration of device and carrier validation mechanisms, leveraging communication networks and cryptographic techniques to confirm identity and ensure secure access to resources.

### 2. Brief Description of the Related Art

The current state of multi-factor authentication (MFA) systems, particularly those relying on SMS-based one-time passwords (OTPs), suffers from significant vulnerabilities that compromise security and reliability. Despite its widespread adoption, SMS-based MFA is plagued by deficiencies stemming from technical limitations and systemic weaknesses, which render it unsuitable for high-security applications.

One of the most critical drawbacks is the lack of end-to-end encryption in SMS communication protocols. SMS messages, including OTPs, are transmitted over channels that remain unencrypted at multiple points during transit. Attackers can intercept these messages using techniques such as man-in-the-middle (MITM) attacks, cell tower spoofing, or rogue base station attacks. The reliance on the outdated Signaling System 7 (SS7) protocol exacerbates this vulnerability, as SS7 lacks modern security mechanisms and is susceptible to unauthorized access. Intercepted OTPs can be exploited to bypass authentication measures, posing severe risks to user accounts and sensitive transactions.

Another major vulnerability arises from the reliance on a phone number as the primary identifier in SMS-based MFA systems. Attackers commonly exploit this reliance through SIM swapping and number porting attacks. In these scenarios, an attacker fraudulently transfers a victim's phone number to a new SIM card under their control. This allows the attacker to receive all SMS messages, including OTPs, intended for the victim. Weak identity verification processes employed by mobile carriers, such as the use of easily compromised personal information, further amplify the risk of such attacks.

SMS-based MFA also fails to address the trustworthiness of the device receiving the OTP. Current systems do not validate whether the device is authentic or authorized to receive sensitive authentication data. As a result, attackers can register disposable or virtual numbers and leverage them to circumvent authentication measures. Furthermore, malware on a user's device can intercept and exfiltrate OTPs without the user's knowledge, exploiting the lack of device-level verification mechanisms.

The systemic reliance on SS7 introduces additional risks beyond message interception. Attackers can exploit SS7 to manipulate message routing, track user locations, or impersonate legitimate carriers. These vulnerabilities persist irrespective of user behavior, highlighting the fundamental insecurity of SMS as a communication medium for authentication.

Replay attacks represent another weakness in SMS-based MFA. OTPs intercepted during transmission can be reused by attackers to gain unauthorized access to systems or complete fraudulent transactions. While many systems impose time-based expiration limits for OTPs, these measures do not adequately counter attackers capable of exploiting intercepted OTPs within the validity period.

The usability and accessibility challenges of SMS-based MFA further undermine its effectiveness. Delays in OTP delivery caused by network congestion, international roaming issues, or outages can prevent timely authentication, disrupting user access to critical services. Additionally, SMS-based systems exclude individuals without access to mobile phones, reducing inclusivity and presenting barriers for certain user groups.

From a regulatory perspective, SMS-based MFA often fails to meet the stringent security requirements mandated by frameworks such as the General Data Protection Regulation (GDPR) and the California Consumer Privacy Act (CCPA). The transmission of unencrypted OTPs raises concerns about data privacy, exposing organizations to potential legal and financial liabilities.

Finally, SMS-based MFA is highly vulnerable to phishing and social engineering attacks. Attackers can deceive users into divulging OTPs through fraudulent SMS messages, voice calls, or emails, bypassing the intended security measures. These attacks exploit human behavior rather than technical weaknesses, making them particularly difficult to mitigate within the existing framework of SMS-based MFA.

### BRIEF SUMMARY OF THE INVENTION

A device-centric MFA framework establishes trust by validating a device with an OEM identification service and by performing EAP-AKA with the home operator using a UICC-originated IMSI. The device generates an attested blob containing a device MFA public key, IMSI, and device token within a TEE; the cloud MFA service verifies the blob and records a carrier-validated phone number in a cloud wallet for later use.

A bootstrapping procedure protects early exchanges before a long-lived device shared key is in place. The cloud MFA service provisions a time-bounded bootstrap credential that identifies a server public key and a bootstrap key identifier. In the TEE, the device creates a bootstrap client signing key pair, performs a key-establishment operation with the bootstrap public key to derive a bootstrap secret, and sends a signed bootstrap request. After verification of the signature, using the corresponding private key, the service derives the same secret, and uses the secret to encrypt early messages such as an attested blob or a network challenge, validating if provisioning has been done, de-provisioning and anything prior to the establishment of the MFA keys. After validation, a device-specific shared key is established and replaces the bootstrap secret for ongoing operation.

### BRIEF DESCRIPTION OF THE DRAWINGS

For a fuller understanding of the invention, reference should be made to the following detailed description, taken in connection with the accompanying drawings, in which:

FIG. 1 is a call-flow for service activation using ML-KEM initial key exchange.

FIG. 2 is a call-flow for service activation enumerating the AKA process.

FIG. 3 shows enterprise and aggregator integration using device push and user consent.

FIG. 4 shows periodic or event-driven re-keying.

FIG. 5 illustrates attested-blob generation and device validation.

FIG. 6 illustrates carrier validation and storage in the cloud wallet.

FIG. 7 illustrates device validation with OEM ID and home operator checks during device reactivation, including storage in the cloud wallet.

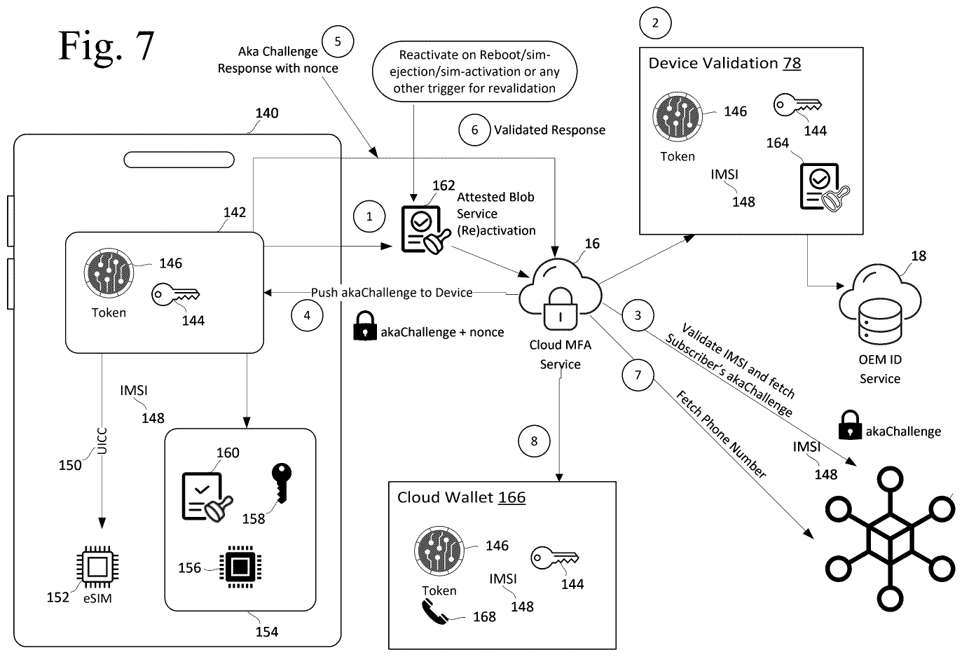

FIG. 8 illustrates push-based user approval for a transaction using a push notification service and an approval dialog on the device.

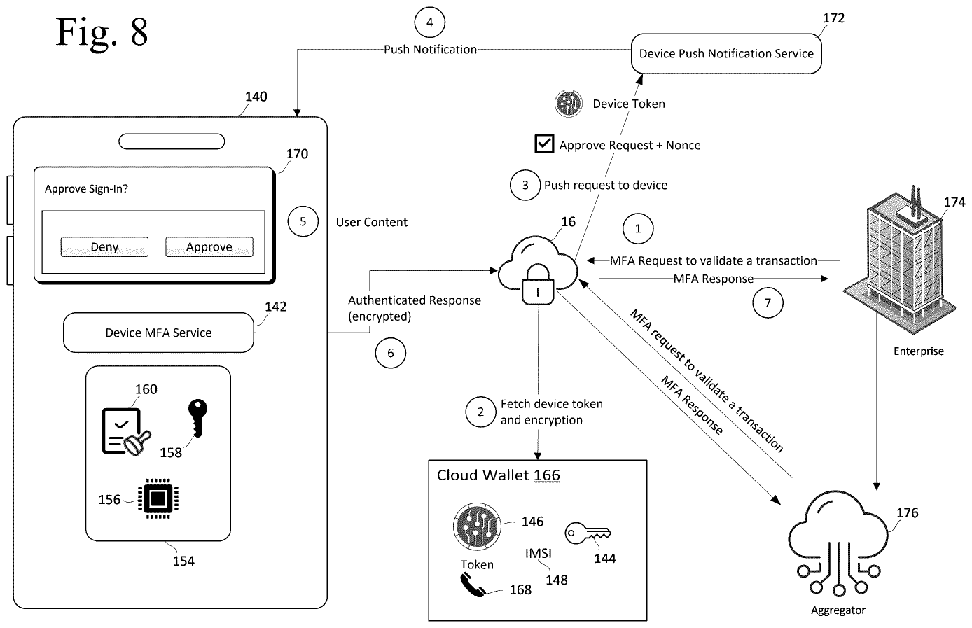

FIG. 9 illustrates an example user-facing login interface that triggers device approval and results in successful authentication.

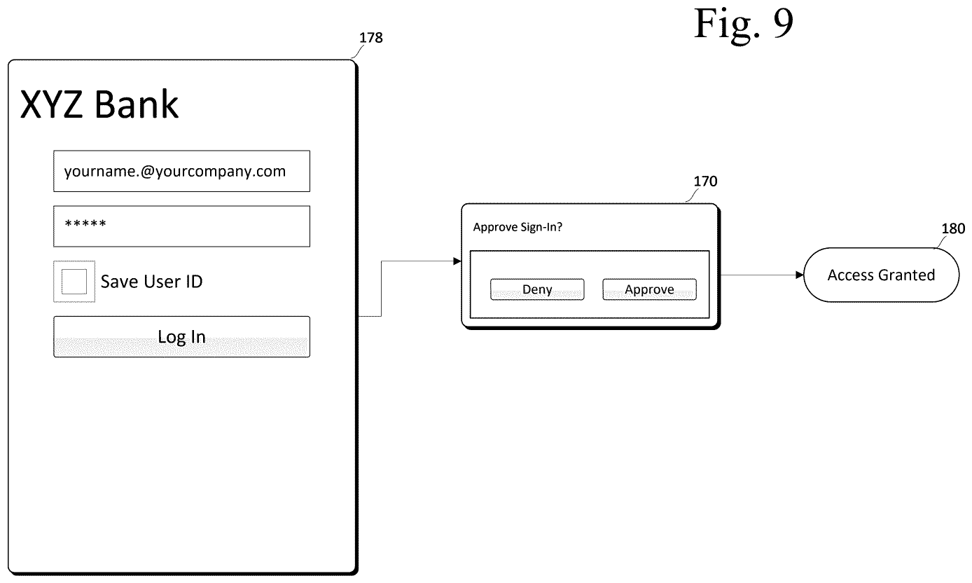

FIG. 10 is a sequence diagram showing enterprise or aggregator integration with the cloud MFA service, a push notification service, and the device TEE for encrypting requests and returning a signed, encrypted user response.

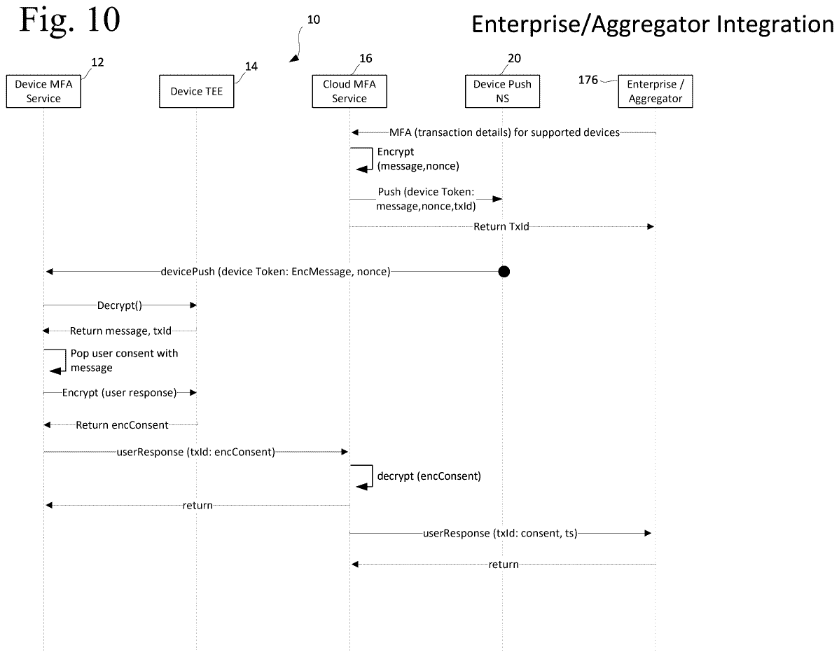

FIG. 11 illustrates bootstrapping using a time-bounded bootstrap credential, including a bootstrap wallet and an OEM bootstrap service that fetches the certificate of the day issued by the Cloud MFA service.

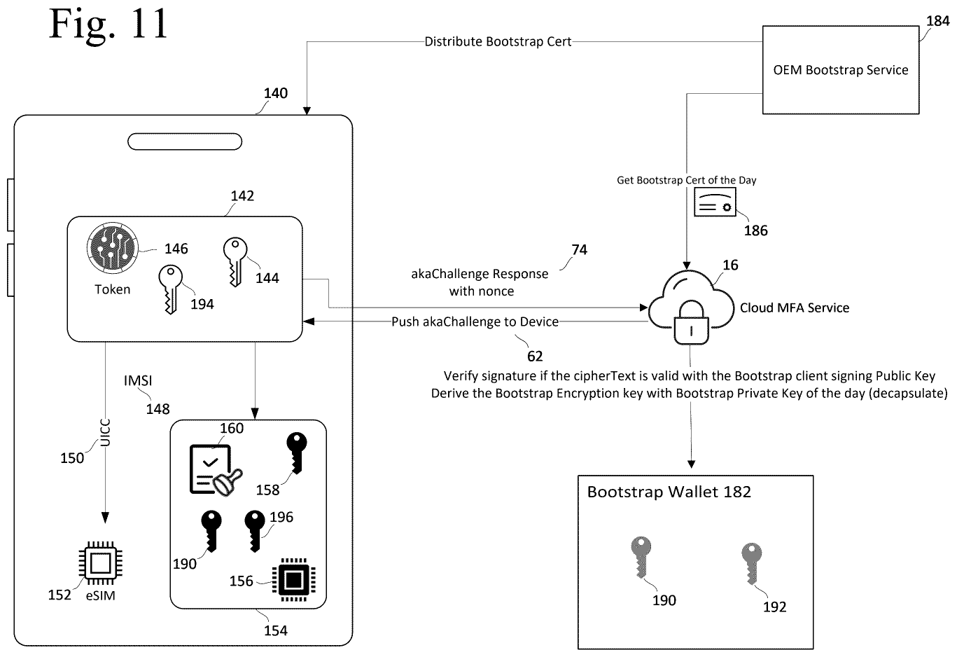

FIG. 12 is a sequence diagram of the bootstrapping flow, including generation of a device bootstrap signing key, encapsulation using a bootstrap server public key, signature verification, and decapsulation with the server private key of the day.

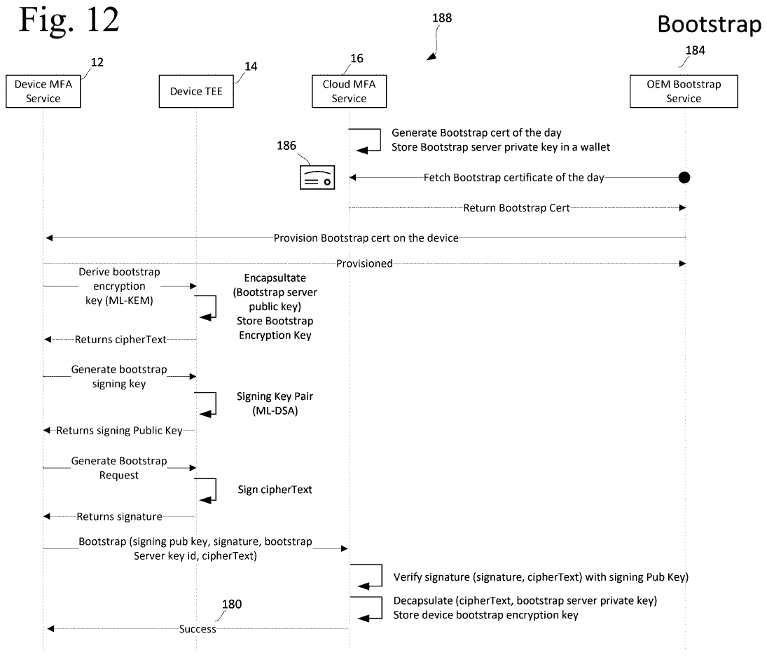

### DETAILED DESCRIPTION OF THE PREFERRED EMBODIMENT

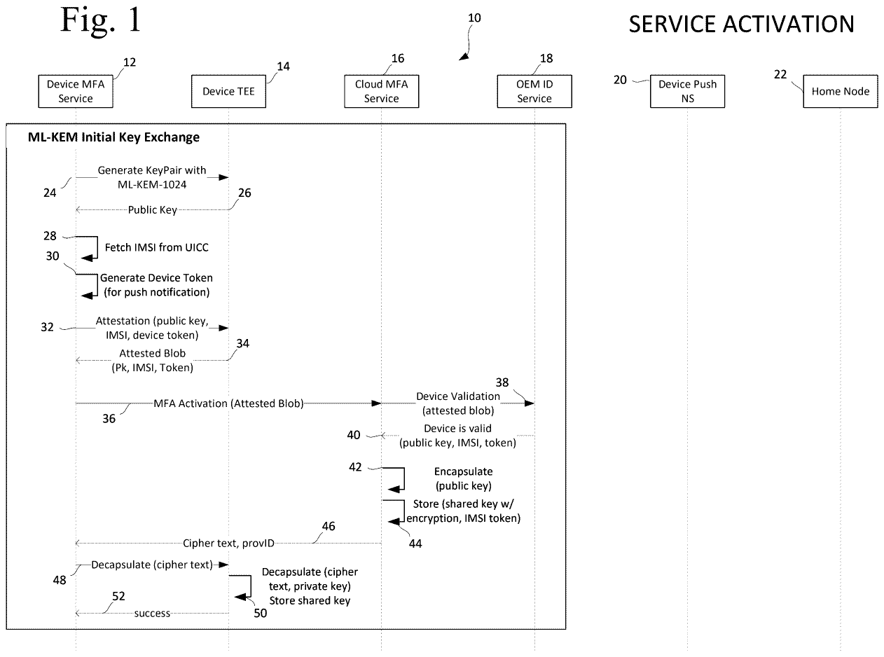

FIG. 1 illustrates the call flow for service activation, focusing on the ML-KEM (Modular Lattice Key Encapsulation Mechanism) initial key exchange process. The entities involved include the Device MFA Service (12), the Device TEE (14), the Cloud MFA Service (16), the OEM ID Service (18), the Device Push Notification Service (20), and the Home Node (22). Each element plays a distinct role in establishing mutual trust between the user device and the network.

The process begins at step (24), where the Device MFA Service generates a key pair using the ML-KEM-1024 algorithm. This cryptographic key pair ensures secure communication and encapsulation of data. The public key is extracted at step (26) from the Device TEE (14), a secure environment within the device designed to protect sensitive data.

At step (28), the Device MFA Service (12) fetches the International Mobile Subscriber Identity (IMSI) from the Universal Integrated Circuit Card (UICC). The IMSI serves as a unique identifier for the user device within the carrier network. Subsequently, at step (30), the Device MFA Service (12) generates a device token, which is used for push notification and session tracking during the authentication process. These elements are bundled together with the public key at step (32) to create an attested blob. This attested blob, which includes the public key, IMSI, and device token, is cryptographically signed by the TEE and is returned to the Device MFA service (34). The attested blob is transmitted to the Cloud MFA Service (16) at step (36) as part of the MFA activation process.

Upon receiving the attested blob at step (36), the Cloud MFA Service validates the request, and the Cloud MFA Service communicates with the OEM ID Service (18) at step (38) to confirm the legitimacy of the device by verifying the cryptographic signature of the blob. Once the device is verified, the packaged elements inside the blob like the public key, IMSI and device token are returned to the Cloud MFA Service (40). The cloud MFA service encapsulates the public key at step (42) to generate a shared key, which is stored alongside the IMSI and device token in encrypted form at step (44) and the generated cipher text is used to send back to the device.

The process concludes with step (46), where the generated cipher text and other tracking data are transmitted back to the Device MFA Service for decapsulation. The Device MFA Service uses its private key to decapsulate the cipher text and retrieve the shared key at step (48). This successful key exchange, confirmed at step (52), ensures that the device and network are securely synchronized for subsequent authentication processes. The decapsulated shared key is stored in the TEE (50) for subsequent cryptographic operation.

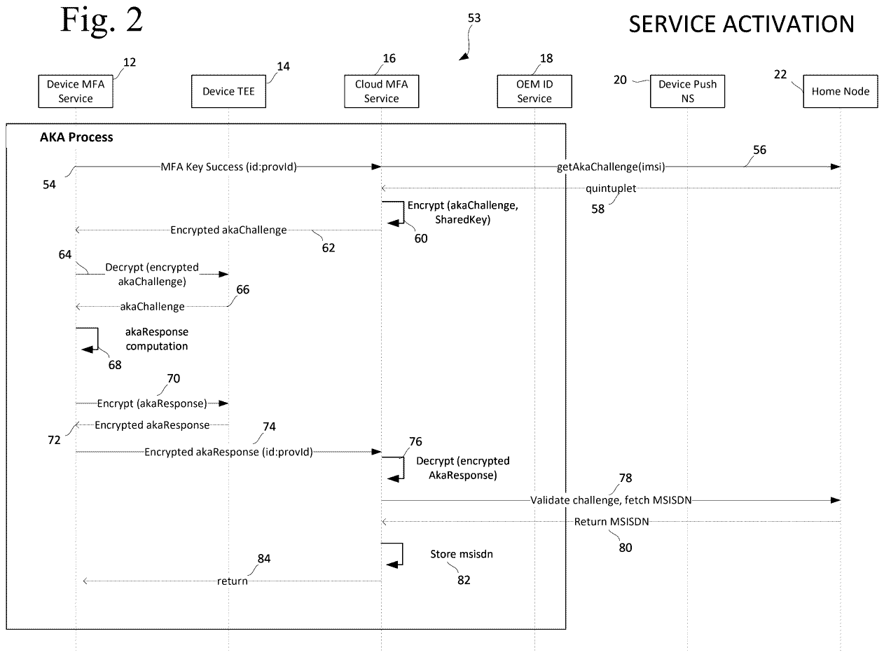

FIG. 2 expands on service activation by detailing the Extensible Authentication Protocol-Authentication and Key Agreement (EAP-AKA) process. This process establishes mutual trust between the user device and the carrier network. As in FIG. 1, the key entities include the Device MFA Service (12), Device TEE (14), Cloud MFA Service (16), OEM ID Service (18), Device Push Notification Service (20), and Home Node (22).

The sequence begins with step (54), where the Device MFA Service confirms the successful establishment of the shared key generated during the initial key exchange. At step (56), the Cloud MFA Service sends a request to the Home Node (22) to initiate the AKA process, transmitting the IMSI retrieved earlier. The Home Node responds at step (58) with a quintuplet containing the necessary cryptographic parameters for the AKA process.

At step (60), the Cloud MFA Service encrypts the akaChallenge using the shared key before forwarding it to the Device MFA Service at step (62). Upon receiving the encrypted akaChallenge, the Device MFA Service decrypts it at step (64, 66) and uses the IMSI to compute the akaResponse at step (68). This computation leverages secure algorithms stored in the UICC. Additional cryptographic function is performed with the keys stored on the UICC and is added to the akaResponse (68).

The akaResponse is encrypted at step (70, 72) and sent back to the Cloud MFA Service at step (74). The Cloud MFA Service decrypts the encrypted akaResponse at step (74) and checks for the expected response (78) and performs a cryptographic validation before sending the request to the Home Node to retrieve the MSISDN (78). The Home Node retrieves the associated MSISDN (Mobile Subscriber Integrated Services Digital Network Number) from its database. The MSISDN, which serves as the validated phone number, is returned to the Cloud MFA Service at step (80) and securely stored in the cloud wallet at step (82). The successful response is returned to the Device MFA client (84) to conclude the provisioning process.

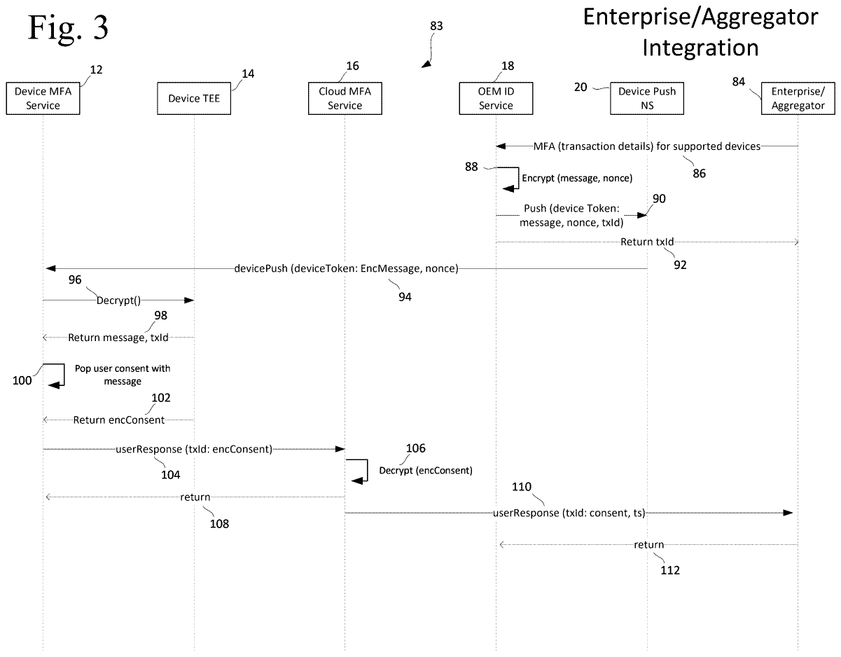

FIG. 3 illustrates the integration of the Cloud MFA Service with enterprise systems and aggregators. This diagram highlights the use of device push notifications for user consent validation and transaction approval.

The process begins at step (86), where the Enterprise/Aggregator (84) transmits transaction details to the Cloud MFA Service. The Cloud MFA Service encrypts the message and nonce using the device's shared key at step (88). The encrypted data is sent to the Device Push Notification Service at step (90), which pushes the notification to the user device at step (94). The user device decrypts the message at step (96) and displays the transaction details to the user at step (100).

At step (100), the user provides consent or denial for the transaction. The Device MFA Service encrypts the user's response at step (102) and transmits it back to the Cloud MFA Service at step (104). The Cloud MFA Service decrypts the user response at step (106) and verifies the consent. The acknowledgement is sent back to the device at step 108. The response sent by the device user (approval or denial), the Cloud MFA Service forwards the consent results to the Enterprise/Aggregator at step (110), completing the transaction workflow at step (112).

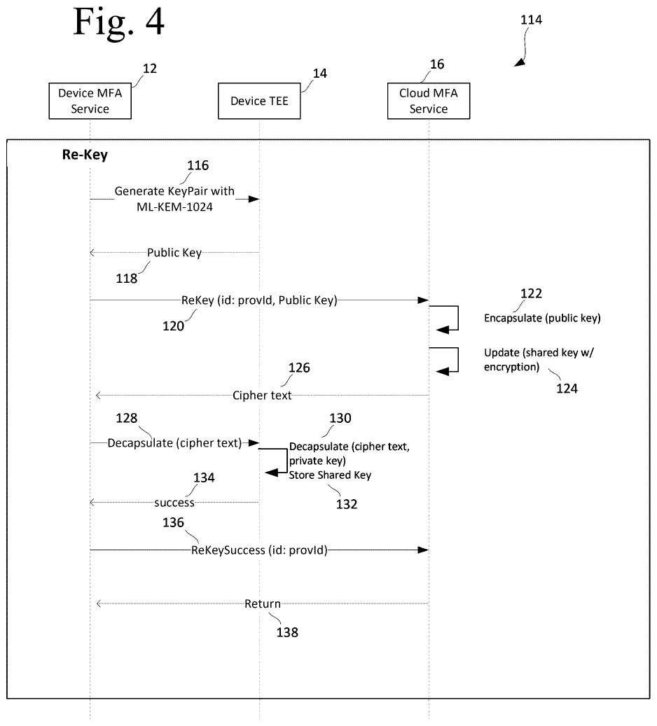

FIG. 4 details the re-keying process, which is triggered as a standard best security policy based on a periodic basis. This ensures the security of the system is maintained. On any device event like UICC replacement, SIM ejection, or device reactivation, the reprovisioning process would start from the beginning to reestablish the trust.

At step (116), the Device MFA Service generates a new cryptographic key pair using the ML-KEM-1024 algorithm. The public key is sent back from the Device TEE at step (118) and subsequently forwarded to the Cloud MFA Service at step (120). The Cloud MFA Service encapsulates the new public key at step (122) to generate an updated shared key, which is securely stored at step (124).

At step (126), the generated cipher text is transmitted to the Device MFA Service, where it is decapsulated at step (128) using the private key. The successful decapsulation and storage of the updated shared key at step (132) ensure that all subsequent communications are encrypted with the latest cryptographic parameters is acknowledged at step (134). The re-keying process concludes with a confirmation message sent to the Cloud MFA Service at step (136), signifying the completion of the re-keying process with an acknowledgement from Cloud MFA Service at step (138).

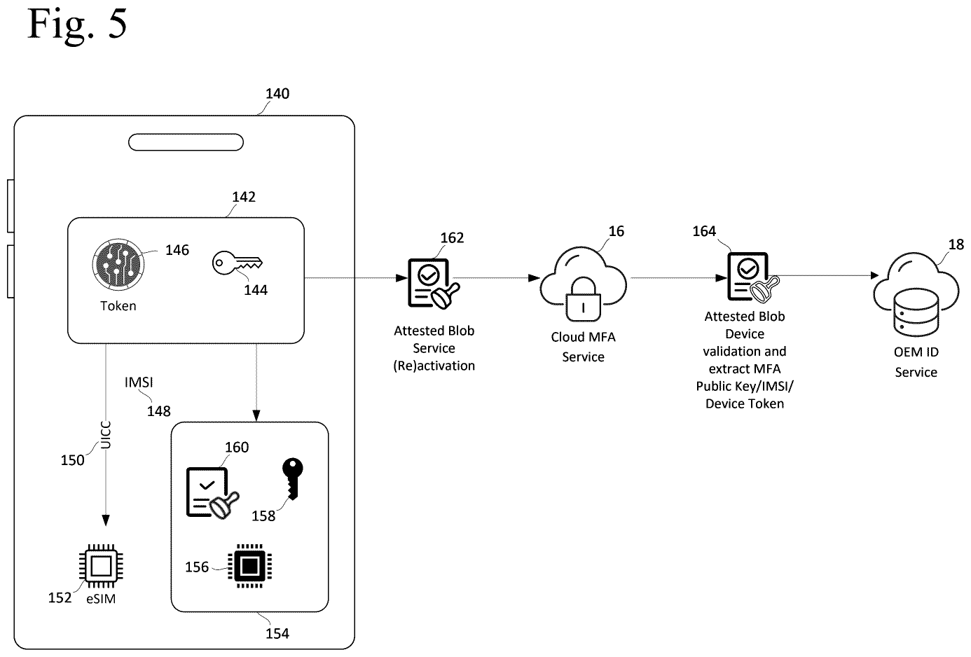

FIG. 5 illustrates the process of service activation and revalidation on a user device (140), emphasizing the generation and validation of an attested blob. The key components include the device MFA service (142), the trusted execution environment (TEE) (154), and the cloud MFA service (16). This figure showcases the roles of device cryptographic elements and their interaction with the cloud MFA service and OEM ID service (18).

The sequence begins within the user device (140), where the device MFA service (142) generates a device token (146) and a key pair comprising an MFA public key (144) and an MFA private key (158). These keys are securely managed within the trusted execution environment (TEE) (154). Concurrently, the IMSI (148) is fetched from the UICC (150) which can be a regular or eSIM (152), providing the unique identifier for the device within the carrier network. The immutable device identity (156), which is assigned by the OEM and resides in the TEE, is also included in this process to establish device authenticity.

At this stage, the attestation process occurs within the TEE (160). The TEE combines the MFA public key (144), IMSI (148), and device token (146) to generate an attested blob (162). This cryptographically signed blob encapsulates all the elements required for authentication. The attested blob is then transmitted to the cloud MFA service (16), which validates its contents via the OEM ID service (18). This validation ensures that the information received from the user device (140) is legitimate and untampered.

Once the cloud MFA service (16) validates the request, the attested blob is forwards the blob to the OEM ID service (18) for additional verification (164). The OEM ID service cross-references the attested blob with the immutable device identity (156) to ensure the device's legitimacy. Upon successful validation, the OEM ID service confirms the integrity of the device to the cloud MFA service, completing the revalidation phase. This process serves for maintaining trust within the authentication framework, especially after events like SIM ejection, device reboots, or UICC replacements.

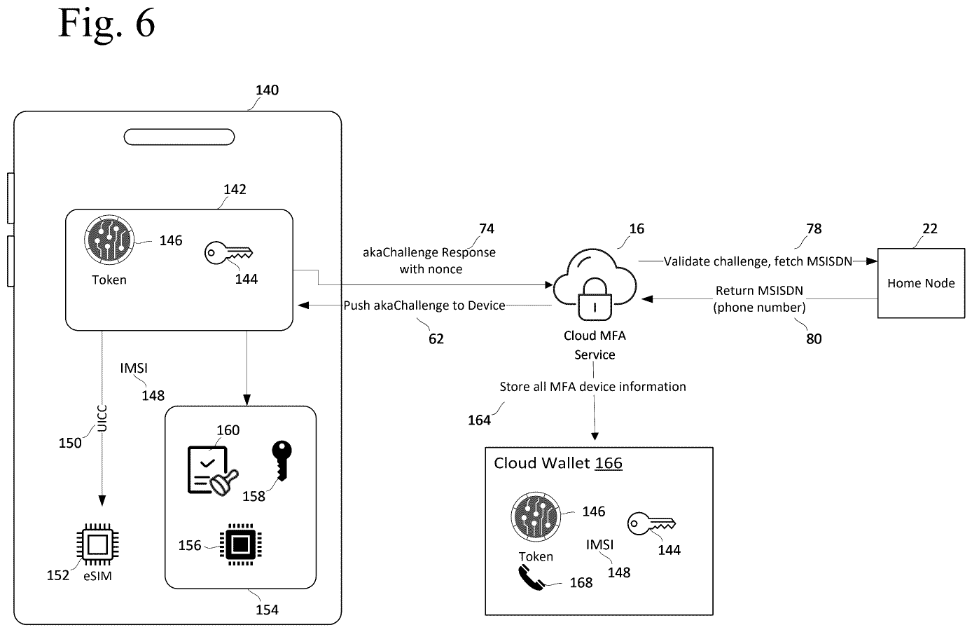

FIG. 6 expands upon the service activation process by illustrating the Extensible Authentication Protocol-Authentication and Key Agreement (EAP-AKA) process, along with the storage of validated data in the cloud wallet (166). The figure highlights interactions between the device MFA service (142), the cloud MFA service (16), the home node (22), and the cloud wallet.

The sequence begins after the successful revalidation described in FIG. 5. The cloud MFA service (16) initiates the EAP-AKA process by transmitting an IMSI (148) to the home node (22. The home node processes the IMSI to generate an akaChallenge, nonce and cryptographic keys for validation, which it returns to the cloud MFA service (16). The cloud MFA service forwards this challenge to the device MFA service (142) (62).

Within the user device (140), the device MFA service (142) decrypts and processes the akaChallenge using the IMSI (148), the MFA private key (158), and the cryptographic capabilities of the trusted execution environment (154). The device MFA service computes the akaResponse and the cryptographic response, which is then encrypted and transmitted back to the cloud MFA service (74).

The cloud MFA service validates the akaResponse as indicated by the home node (22) for validation along with the cryptographic function. After successful validation of the akaResponse, the Cloud MFA Service (78), the request is sent to the Home Node for fetching the MSISDN (80). The Home Node uses its database and retrieves the Mobile Station International Subscriber Directory Number (MSISDN), also known as the validated phone number (168). The home node transmits the MSISDN back to the cloud MFA service (80).

Upon receiving the validated phone number, the cloud MFA service securely stores the phone number (168), along with the device token (146), MFA public key and its shared key (144), and IMSI (148), in the cloud wallet (166). The cloud wallet serves as a secure repository for authentication data, enabling

To protect early communications before a device-specific shared key is established, a bootstrapping procedure is used in which the bootstrap key identifier maps to a certificate-of-the-day value provisioned by the OEM bootstrap service. The cloud MFA service 16 generates the certificate-of-the-day, the OEM bootstrap service 184 fetches the cert, a time-bounded bootstrap credential 186 that identifies a bootstrap server public key and a bootstrap key identifier for a defined validity window. The associated bootstrap server private key of the day 192 is stored in a bootstrap wallet 182.

On the device 140, the device MFA service 142, executing within the TEE 154, generates a bootstrap client signing key pair 196 and exposes the bootstrap client signing public key 194. The device performs a post-quantum key-establishment operation (for example, ML-KEM) using the bootstrap credential public key to derive a first bootstrap secret and produce bootstrap key-establishment data (ciphertext).

The device forms a bootstrap request that includes the bootstrap key identifier, the bootstrap key-establishment data, the bootstrap client signing public key 194, and a digital signature computed with the bootstrap client signing private key over at least the bootstrap key-establishment data and the bootstrap key identifier. The request is transmitted to the cloud MFA service 16.

Using the private key associated with the bootstrap credential, the cloud MFA service verifies the digital signature with the bootstrap client signing public key 194. Upon successful verification, derives a second bootstrap secret by decapsulating the bootstrap key-establishment data, and the service stores the second bootstrap secret in association with the device token 146 and IMSI 148 in the bootstrap wallet 182 and uses the bootstrap secret to encrypt early messages (for example, checking for provisioning/de-provisioning request, initial data security, an attested blob 162 or an AKA challenge) prior to establishment of a device-specific shared key.

The bootstrap credential may be short-lived and rotated on a schedule (for example, daily, monthly, or quarterly). A re-bootstrap can be triggered by device reactivation events including SIM ejection, UICC replacement, device reboot, firmware update, or rotation of the bootstrap credential. After validation is complete and a device-specific shared key is established, the bootstrap secret is retired and the device communicates using the device-specific shared key.

TABLE OF REFERENCE NUMERALS

| | |
|---|---|
| 10: | ML-KEM initial key exchange (process in service activation) |
| 12: | Device MFA Service |
| 14: | Device TEE |
| 16: | Cloud MFA Service |
| 18: | OEM ID Service |
| 20,172: | Device Push Notification Service |
| 22: | Home Node |
| 53: | AKA process (service activation process) |
| 83: | Enterprise/Aggregator integration process |
| 114: | Re-keying process |
| 116: | Generate new key pair during re-keying |
| 118: | Public key (during re-keying) |
| 120: | Encapsulate public key |
| 122: | Update shared key with encryption |
| 124: | Cipher text for re-keying |
| 126: | Decapsulate cipher text |
| 128: | Private key (during re-keying) |
| 130: | Store shared key after decapsulation |
| 132: | ReKeySuccess message |
| 134: | Return process for re-keying |
| 136: | Completion of re-keying |
| 140: | User Device |
| 142: | Device MFA Service |
| 144: | MFA Public Key |
| 146: | Device Token |
| 148: | IMSI (International Mobile Subscriber Identity) |
| 150: | UICC (Universal Integrated Circuit Card) |
| 152: | eSIM |
| 154: | Trusted Execution Environment (TEE) |
| 156: | Immutable Device Identity |
| 158: | MFA Private Key |
| 160: | Attestation in TEE |
| 162: | Attested Blob |
| 164: | Validation of attested blob by Cloud MFA Service and/or |
| | OEM ID Service |
| 166: | Cloud Wallet |
| 168: | Phone Number (MSISDN) |
| 170: | Approval Dialog |
| 174: | Enterprise |
| 176: | Aggregator |
| 178: | User-facing log in interface |
| 180: | Successful authentication |
| 182: | Bootstrap Key Wallet |
| 184: | OEM Bootstrap Service |
| 186: | Bootstrap Certificate of the Day |
| 188: | Bootstrap Flow |
| 190: | Bootstrap Encryption Key (device) |
| 192: | Bootstrap Server Private Key of the day (cloud) |
| 194: | Bootstrap Signing Client Public (device) |
| 196: | Bootstrap Client Signing Key (device) |

### Computer and Software Technology

The present invention may be embodied on various platforms. The following provides an antecedent basis for the information technology that may be utilized to enable the invention.

Embodiments of the present invention may be implemented in hardware, firmware, software, or any combination thereof. Embodiments of the present invention may also be implemented as instructions stored on a machine-readable medium, which may be read and executed by one or more processors. A machine-readable medium may include any mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared signals, digital signals, etc.), and others.

Further, firmware, software, routines, instructions may be described herein as performing certain actions. However, it should be appreciated that such descriptions are merely for convenience and that such actions in fact result from computing devices, processors, controllers, or other devices executing the firmware, software, routines, instructions, etc.

The machine-readable medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any non-transitory, tangible medium that can contain, or store a program for use by or in connection with an instruction execution system, apparatus, or device. Storage and services may be on premise or remote such as in the “cloud” through vendors operating under the brands, MICROSOFT AZURE, AMAZON WEB SERVICES, RACKSPACE, and KAMATERA.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a computer readable storage medium and that can communicate, propagate, or transport a program for use by or in connection with an instruction execution system, apparatus, or device. However, as indicated above, due to circuit statutory subject matter restrictions, claims to this invention as a software product are those embodied in a non-transitory software medium such as a computer hard drive, flash-RAM, optical disk or the like.

Program code embodied on a machine-readable medium, whether for smartphone applications or telecom networking infrastructure, may be transmitted using a wide variety of media. These media include wireless communication channels such as cellular networks (e.g., 4G, LTE, and 5G), Wi-Fi, and Bluetooth, as well as wire-line connections like Ethernet and DSL. Optical fiber cables, known for their high bandwidth and low latency, are critical for transmitting large data volumes in telecom backhaul networks. Additionally, radio frequency (RF) transmission, commonly used in satellite communications and base station links, may also serve as a conduit for transmitting program code. These transmission media can operate independently or in combination, enabling robust, redundant, and high-performance communication essential for modern smartphone applications and telecom infrastructure.

Machine-readable program code designed to implement operations for aspects of the present invention may be written in any combination of one or more programming languages. Object-oriented programming languages such as Java, C#, C++, and Rust are particularly suited for both smartphone application development and telecom networking systems. For smartphones, object-oriented languages facilitate modular design, enabling the development of applications that are scalable, maintainable, and efficient. These languages also power the frameworks and libraries used to manage device-specific features such as camera operations, location services, and user interfaces. In telecom networking, object-oriented programming is instrumental in building modular components for signaling protocols, network management systems, and software-defined networking (SDN) controllers. Rust, with its focus on memory safety and performance, is emerging as a valuable language for ensuring secure and efficient operations in both domains.

In addition to object-oriented languages, conventional procedural programming languages such as C remain a cornerstone of telecom infrastructure and smartphone firmware development. The C programming language, with its ability to directly interface with hardware, is frequently used in implementing device drivers, protocol stacks, and embedded systems. In smartphones, C is often utilized for performance-critical operations and battery optimization, ensuring that applications and core functions operate seamlessly. In telecom networks, C plays a vital role in the real-time processing of data, such as handling signaling protocols like SS7 and SCTP or managing packet switching in routers and switches.

Scripting languages, such as Python, Lua, and Perl, also hold significant relevance in both smartphone development and telecom systems. Python's simplicity and extensive libraries make it a popular choice for automating testing frameworks, developing AI-driven smartphone applications, and performing data analytics on mobile usage patterns. Lua, with its lightweight footprint and high execution speed, is often embedded within applications to provide extensibility and scripting capabilities for end-users. Similarly, Perl is widely used in telecom infrastructure for parsing log files, automating network configuration tasks, and managing large-scale telecom datasets. These scripting languages provide agility and flexibility, enabling developers to rapidly prototype, test, and deploy solutions in dynamic environments.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by machine-readable program instructions.

### Glossary of Claim Terms

Attestation Signature means a cryptographic signature generated by the device MFA service to certify the authenticity and integrity of specific device data transmitted to the cloud MFA service. This data includes, but is not limited to, the device MFA public key, the Universal Integrated Circuit Card (UICC)-originated International Mobile Subscriber Identity (IMSI), and the device token. The attestation signature is created using a private key stored within the Trusted Execution Environment (TEE) of the user device, ensuring that it originates from a secure and tamper-resistant environment. Upon receiving the attestation signature as part of the attested blob, the cloud MFA service via Original Equipment Manufacturer (OEM) identification service verifies the signature using the corresponding public key. This verification step confirms that the attested blob originates from a trusted device and has not been tampered with during transmission. The attestation signature ensures that the device participating in the authentication process is both genuine and authorized. This mechanism plays a vital role in establishing a secure and trustworthy communication channel between the user device, the cloud MFA service, and other entities such as the Original Equipment Manufacturer (OEM) identification service and the home operator node. The use of cryptographic attestation signatures further safeguards against spoofing, replay attacks, or unauthorized devices attempting to gain access to the network. By providing a cryptographically secure mechanism for device validation, the attestation signature forms the foundation of trust in the multi-factor authentication (MFA) ecosystem, facilitating subsequent secure exchanges of sensitive information such as cryptographic keys and session tokens.

Attested Blob means a cryptographically secured data structure generated by the device MFA service, containing critical information used for device validation during multi-factor authentication. The attested blob includes the device MFA public key, the UICC-originated IMSI, the device token, and the attestation signature. The device MFA service creates the attested blob within the Trusted Execution Environment (TEE) of the user device to ensure the integrity and security of the data. Once generated, the attested blob is transmitted to the cloud MFA service for validation. The attestation signature within the attested blob provides cryptographic proof of the authenticity and integrity of the included data. The cloud MFA service via Original Equipment Manufacturer (OEM) uses this signature to confirm that the blob originates from a trusted device and has not been altered during transmission. After validating the attested blob, the cloud MFA service forwards it to the Original Equipment Manufacturer (OEM) identification service for further verification of the device's legitimacy. The attested blob enables the cloud MFA service to establish a secure and trusted relationship between the user device, the network, and other participating entities. This structure ensures that all subsequent steps in the authentication process, including the execution of the Extensible Authentication Protocol-Authentication and Key Agreement (EAP-AKA) procedure, are performed with a verified and authorized device. By incorporating cryptographic validation at this stage, the attested blob mitigates risks associated with device spoofing, unauthorized access, and tampering, reinforcing the security of the overall MFA framework.

AkaChallenge means a cryptographic challenge issued by a home operator node during the Extensible Authentication Protocol-Authentication and Key Agreement (EAP-AKA) process. The akaChallenge is a core component of mutual authentication between a user device and the network. It typically includes a sequence number, nonce, session-specific data, and other cryptographic elements required for the authentication process. Upon generating the akaChallenge, the home operator node transmits it to the user device via the cloud MFA service. The challenge is processed by the device using the cryptographic keys and algorithms stored on the Universal Integrated Circuit Card (UICC). The device generates an akaResponse in reply to the akaChallenge, which is then sent back to the MFA Cloud Service on behalf of the home operator node for validation. The purpose of the akaChallenge is to confirm the legitimacy of both the device and the network by requiring the device to perform cryptographic operations that can only be executed with valid UICC-stored keys. This ensures that the device attempting to authenticate is genuine and authorized to access network resources. The akaChallenge also facilitates the establishment of session keys used to secure further communication between the device and the network. By incorporating cryptographic principles, the akaChallenge ensures that the authentication process is resistant to replay attacks, tampering, and unauthorized access. Its role in establishing mutual trust and securing network sessions makes the akaChallenge a fundamental element of secure multi-factor authentication.

AkaResponse means a cryptographic response generated by a user device in reply to an akaChallenge during the Extensible Authentication Protocol-Authentication and Key Agreement (EAP-AKA) process. The akaResponse is created using the cryptographic keys and algorithms stored on the Universal Integrated Circuit Card (UICC) of the user device. Upon receiving the akaChallenge, the device processes the included nonce and associated cryptographic parameters, computing the akaResponse as proof of its authenticity. The akaResponse is then transmitted back to the cloud MFA service for validation. The Cloud MFA Service on behalf of the home operator node verifies the response by comparing it against the expected output based on the original akaChallenge. A successful match along with the cryptographic function match confirms the authenticity of the device and establishes mutual trust between the device and the network. The akaResponse also enables the derivation of session keys, which are used to encrypt and secure subsequent communications between the device and the network. This step is critical for ensuring that only authorized devices gain access to network resources. The akaResponse is resistant to tampering and replay attacks, as it relies on cryptographic principles and time-sensitive nonces. By requiring the generation and verification of the akaResponse, the EAP-AKA process ensures that the authentication protocol remains robust and secure against impersonation and other unauthorized activities. The aka Response is a cornerstone of the overall security architecture, enabling the safe exchange of sensitive information in a multi-factor authentication framework.

Bootstrap Credential means a time-bounded credential that enables secure initialization of a device before a device specific shared key exists. The credential contains at least: (i) a bootstrap server public key, (ii) a bootstrap key identifier that references a validity window such as a certificate of the day, and (iii) metadata sufficient to locate the corresponding server private key maintained by the cloud MFA service. An OEM bootstrap service fetches the credential from the cloud MFA service and distributes it to supported devices. During bootstrapping the device uses the bootstrap server public key in a key establishment operation, for example a NIST standard postquantum KEM such as MLKEM, to produce bootstrap key establishment data and to derive a provisional secret. The bootstrap key identifier allows the cloud MFA service to select the correct private key to complete decapsulation during that validity window and to reject expired credentials. The credential may be cached on the device for the validity period and rotated on a defined schedule to limit exposure and to support re-bootstrapping after reactivation events.

Bootstrap Wallet means a secure logical repository operated by the cloud MFA service for managing server and device state related to bootstrapping. The wallet stores, for each bootstrap key identifier within its validity window, the corresponding server private key of the day and policy metadata such as activation time, expiration time, and permissible message types. Upon successful verification of a device's bootstrap request, the wallet records a device-associated bootstrap secret that results from decapsulation using the server private key and the device's bootstrap key-establishment data. The wallet associates the bootstrap secret with a device token, an IMSI, timestamps, and an audit trail to enable encryption and authentication of early messages, including delivery of an attested blob or carrier challenges. The wallet may enforce automatic secret expiration upon establishment of the device-specific shared key or upon rotation of the bootstrap credential. The wallet is distinct from, but may interoperate with, a cloud wallet that stores long-lived device MFA data.

Bootstrap Secret means a symmetric key that both the device and the cloud MFA service derive during bootstrapping by executing a cryptographic key-establishment operation with the bootstrap credential. On the device, the TEE derives the secret while forming the bootstrap request; at the service, the secret is derived by decapsulating the received key-establishment data with the server private key of the day. The bootstrap secret is strictly provisional and is scoped to early exchanges such as encrypting an attested blob, protecting a network challenge, or delivering configuration needed to complete activation. The secret is stored only for its validity window in a bootstrap wallet and is retired automatically when the device-specific shared key is established or when the credential expires. Re-bootstrapping may generate a new bootstrap secret in response to device reactivation events such as SIM ejection, UICC replacement, or firmware updates.

Bootstrap Client Signing Key/Public Key means a digital-signature key pair generated within the device's trusted execution environment for the purpose of authenticating a bootstrap request. The private component remains within the TEE and is used to compute a signature over at least the bootstrap key-establishment data and the bootstrap key identifier, and optionally a server key identifier corresponding to a certificate of the day. The public component is exported and included in the bootstrap request so that the cloud MFA service can verify the signature before accepting any cryptographic material. In some embodiments the public key is bound to the device by inclusion in an attested blob. The service discards unsigned or invalidly signed bootstrap requests and may record the verified public key in association with the bootstrap secret for auditability. The signing key pair can be regenerated during re-bootstrapping and may be distinct from keys used for later MFA operations.

Cipher Text means the encrypted form of data that results from applying a cryptographic algorithm to plaintext using a cryptographic key. In the context of this invention, cipher text is generated during key encapsulation processes such as those using the ML-KEM-1024 algorithm. It is securely transmitted between the user device and the Cloud MFA Service to ensure that sensitive information, including cryptographic keys and authentication data, is protected against interception and unauthorized access. Only authorized entities with the appropriate decryption keys, such as the MFA private key stored in the Trusted Execution Environment (TEE), can convert the cipher text back into its readable plaintext form.

Cloud MFA Service means a cloud-based system that facilitates multi-factor authentication (MFA) by performing device validation, cryptographic operations, and secure data management. The Cloud MFA Service acts as an intermediary between the user device, the Original Equipment Manufacturer (OEM) identification service, and the home operator node to establish mutual trust and secure communication. This service is responsible for receiving attested blobs generated by the device MFA service and verifying the attestation signature to ensure the integrity and authenticity of the device data. Upon validation, the Cloud MFA Service transmits the attested blob to the OEM identification service for device verification. Additionally, the Cloud MFA Service interacts with the home operator node to initiate the Extensible Authentication Protocol-Authentication and Key Agreement (EAP-AKA) process, forwarding the akaChallenge and nonce to the user device and help processing the resulting akaResponse. The service further validates the response by coordinating with the home operator node and retrieves a validated phone number, which it securely stores alongside other device-specific data in a cloud wallet. Beyond these core functions, the Cloud MFA Service encrypts sensitive data using post-quantum cryptographic algorithms to protect against tampering and unauthorized access. It can also initiate processes such as re-provisioning, device reactivation, and user consent validation to maintain the security and integrity of the authentication process. By providing centralized control and cryptographic security, the Cloud MFA Service ensures robust and reliable multi-factor authentication across a variety of devices and networks.

Device MFA Public Key means a cryptographic key generated by the device MFA service for use in secure authentication processes. The Device MFA Public Key is part of a public-private key pair, with the private key stored in the Trusted Execution Environment (TEE) of the user device. This key is included in the attested blob transmitted to the Cloud MFA Service and forms the basis of cryptographic validation and secure communication. Upon receipt, the Cloud MFA Service validates the public key using the attestation signature provided in the attested blob, confirming that the key originates from a trusted device. The Device MFA Public Key's derived shared key is used for various cryptographic functions, including encrypting sensitive data such as transaction details or authentication challenges. In addition, the key facilitates secure exchanges with other entities, such as the Cloud MFA Service, the OEM identification service, and the home operator node. The integrity and authenticity of the Device MFA Public Key are critical for ensuring that only authorized devices participate in the authentication process. This key also plays a central role in cryptographic operations, such as key encapsulation and post-quantum cryptography, further enhancing the security of the multi-factor authentication framework. By leveraging the Device MFA Public Key, the system ensures that all communications involving the user device are encrypted and resistant to tampering, interception, and replay attacks.

Device MFA Service means a software component or module operating on a user device that facilitates the generation and management of cryptographic keys and the preparation of authentication data for multi-factor authentication (MFA). The Device MFA Service is responsible for generating the attested blob, which includes the Device MFA Public Key, the Universal Integrated Circuit Card (UICC)-originated International Mobile Subscriber Identity (IMSI), the device token, and the attestation signature. These elements are securely encapsulated and transmitted to the Cloud MFA Service for validation. Operating within the Trusted Execution Environment (TEE), the Device MFA Service ensures that all cryptographic operations and sensitive data remain protected from unauthorized access or tampering. The service processes authentication challenges, such as the akaChallenge received during the Extensible Authentication Protocol-Authentication and Key Agreement (EAP-AKA) process, and generates the corresponding akaResponse. It may also encrypt user consent responses or transaction details for secure transmission to the Cloud MFA Service. Additionally, the Device MFA Service supports security functions such as reprovisioning, device reactivation, and periodic revalidation of the UICC-originated IMSI. By acting as the trusted interface between the user device and the authentication system, the Device MFA Service ensures that all device-specific authentication data is securely managed and communicated, forming a critical component of the MFA framework.

Device Token means a unique identifier generated by the Device MFA Service and included in the attested blob to enable secure and traceable interactions between the user device and the Cloud MFA Service. The Device Token is tied to the specific device and may be used to track and manage authentication sessions, validate transactions, or store session-related metadata in the secure cloud wallet. The device token is generated for the Device MFA Service and identifies the device and the application by the appropriate Device Push Notification Service. This device token is tied to the MSISDN and is used for the MFA operation for that MSISDN. The Device Token also supports security operations, such as linking the device with cryptographic keys and ensuring that transactions are associated with the correct device. By maintaining the integrity and uniqueness of the Device Token, the authentication system ensures secure, reliable, and efficient management of device-specific interactions in the MFA ecosystem.

Device Push Notification means a secure communication sent by the Cloud MFA Service to a user device to facilitate user consent validation or other authentication-related processes. The notification contains transaction details or authentication requests, encrypted using the Device MFA Public Key's shared key to ensure confidentiality and integrity. Device Push Notifications are triggered when user interaction or confirmation is required, such as approving a transaction, reactivating a device, or validating a new session. Upon receiving the notification, the user device decrypts the content within its Trusted Execution Environment (TEE) and displays it to the user for approval or interaction. The user's consent or response is then securely transmitted back to the Cloud MFA Service. By using cryptographically secured Device Push Notifications, the system ensures that sensitive information remains protected from tampering or interception and that only authorized users can interact with authentication requests.

Device Reactivation Event means an occurrence that triggers the Device MFA Service to revalidate the trust and authentication status of a user device. Examples of Device Reactivation Events include the replacement of a Universal Integrated Circuit Card (UICC), ejection or re-insertion of a SIM card, device restarts, or significant updates to the device's firmware or software. During a reactivation event, the Device MFA Service may require to generate a new key pair, create an updated attested blob, and repeat the validation processes involving the OEM identification service and home operator node. These steps ensure that the device continues to meet the necessary security standards and remains authorized within the multi-factor authentication (MFA) framework. Reactivation Events provide an additional layer of security by verifying that changes to the device environment have not compromised its integrity or authentication credentials.

Extensible Authentication Protocol-Authentication and Key Agreement (EAP-AKA) is an authentication protocol designed for secure communication and mutual authentication between a user device and a carrier network, particularly in 3G, LTE, and 5G environments. Tailored for use with Universal Integrated Circuit Cards (UICC), EAP-AKA begins with the user device transmitting an identifier, such as the International Mobile Subscriber Identity (IMSI), to the home operator node, which may be a Home Location Register (HLR) in 2G/3G networks or a Home Subscriber Server (HSS) in LTE/5G systems. The home operator node generates an authentication vector comprising an akaChallenge, a sequence number, and session keys. The akaChallenge along with the nonce is sent to the device via the network. The device, using its UICC, computes an akaResponse based on the challenge and pre-shared keys stored on the UICC, returning this response to the network for verification. EAP-AKA establishes mutual authentication by ensuring both the device and the network validate each other, safeguarding against man-in-the-middle attacks and unauthorized access. Session keys derived during this process secure subsequent communications, ensuring encryption and integrity. Within this invention, EAP-AKA facilitates trust by allowing the cloud-based multi-factor authentication (MFA) service to transmit the IMSI to the home operator node, receive the akaChallenge, and forward it to the device MFA service. The validated akaResponse enables retrieval of the Mobile Station International Subscriber Directory Number (MSISDN), or phone number, independently of the device, ensuring secure storage in the cloud wallet alongside other critical authentication data such as the device token and MFA public key.

Enterprise/Aggregator Integration means the process by which enterprises and aggregators interact with the Cloud MFA Service to manage authentication and transaction validation. This integration enables secure communication between enterprise systems, such as those handling user accounts or financial transactions, and the Cloud MFA Service. The process involves transmitting transaction details, encrypting them with device MFA public keys, and delivering them to the user device via push notifications. User responses, such as consent or denial, are returned to the enterprise or aggregator through the Cloud MFA Service. This integration facilitates secure, scalable, and traceable interactions across different entities while ensuring user authentication.

Home Location Register (HLR) means a database used in 2G and 3G networks to manage subscriber information and authentication data for mobile devices. The HLR stores the International Mobile Subscriber Identity (IMSI), phone numbers, and associated service profiles for each subscriber. During the authentication process, the HLR interacts with the Cloud MFA Service and the device MFA service by providing subscriber-specific information necessary for initiating and validating the Extensible Authentication Protocol-Authentication and Key Agreement (EAP-AKA) process. The HLR generates authentication challenges, verifies akaResponses, and helps establish secure communication channels between the device and the network. Although the HLR is specific to older network technologies, its functionality aligns with that of the Home Subscriber Server (HSS) in LTE and 5G networks, ensuring compatibility with broader authentication systems.

Home Operator Node means a network entity responsible for managing subscriber authentication and authorization within a mobile carrier network. The Home Operator Node encompasses systems such as the Home Location Register (HLR) in 2G and 3G networks and the Home Subscriber Server (HSS) in LTE and 5G networks. During the authentication process, the Home Operator Node interacts with the Cloud MFA Service to initiate and validate the Extensible Authentication Protocol-Authentication and Key Agreement (EAP-AKA) process. This includes generating akaChallenges, validating akaResponses, and providing session keys or other cryptographic materials. The Home Operator Node also provides the Cloud MFA Service with a validated phone number associated with the device, independently of the phone number stored on the device itself. By facilitating these critical functions, the Home Operator Node ensures secure and trusted interactions between devices, networks, and multi-factor authentication systems.

Home Subscriber Server (HSS) means a central database used in LTE and 5G networks to manage subscriber authentication, authorization, and service profiles. The HSS performs functions similar to the Home Location Register (HLR) in 2G and 3G networks but with additional capabilities tailored to advanced network architectures. The HSS interacts with the Cloud MFA Service and the device MFA service to facilitate the Extensible Authentication Protocol-Authentication and Key Agreement (EAP-AKA) process, providing authentication challenges, validating akaResponses, and issuing session keys. It also provides information necessary for network operations, such as subscriber location tracking and service provisioning. The HSS ensures that devices participating in the authentication process meet the network's security and operational standards.

IMSI means the International Mobile Subscriber Identity, a unique identifier stored on the Universal Integrated Circuit Card (UICC) of a mobile device. The IMSI is used by mobile networks to authenticate and identify subscribers during network access and other operations. During the Extensible Authentication Protocol-Authentication and Key Agreement (EAP-AKA) process, the IMSI is transmitted to the Home Operator Node, which uses it to generate an akaChallenge and validate the device's akaResponse. The IMSI is also included in the attested blob transmitted by the device MFA service to the Cloud MFA Service, ensuring that the device's identity can be verified. By relying on the IMSI as a key component of the authentication process, the system ensures accurate and secure identification of subscribers within the multi-factor authentication (MFA) framework.

Metadata means supplemental data that describes or provides information about the operational state or configuration of a device during the authentication process. Metadata may include information about the device's firmware version, UICC status, cryptographic key status, or prior authentication events. Metadata is often included in the validated akaChallenge response generated by the device MFA service and transmitted to the Cloud MFA Service. This data is securely stored in the cloud wallet for future reference, enabling the system to monitor device integrity, detect anomalies, and enforce security policies. By including metadata in the authentication process, the system enhances its ability to identify and respond to potential security risks.

ML-KEM (Modular Lattice Key Encapsulation Mechanism) refers to a cryptographic algorithm designed for secure key exchange and encapsulation, leveraging lattice-based cryptography to resist quantum computing attacks. In the context of the invention, ML-KEM plays a role in the initial key exchange process during multi-factor authentication (MFA) service activation. Its use ensures that sensitive cryptographic keys can be securely transmitted and stored while maintaining resistance to both classical and quantum computational threats. The ML-KEM process begins with the generation of a cryptographic key pair by the Device MFA Service. This key pair comprises an MFA Public Key, which is encapsulated and transmitted, and an MFA Private Key, which remains securely stored within the Trusted Execution Environment (TEE) of the user device. The encapsulation process, enabled by ML-KEM, generates a shared key alongside a ciphertext that can only be decrypted by the recipient possessing the corresponding private key. This shared key is then used to encrypt subsequent communications between the device and the Cloud MFA Service. The lattice-based foundation of ML-KEM provides inherent security advantages, including robustness against mathematical attacks such as those exploiting the structure of elliptic curves or integer factorization, which are vulnerabilities in traditional cryptographic methods. By adopting ML-KEM, the system ensures the confidentiality and integrity of cryptographic operations even in a post-quantum environment. In this invention, ML-KEM is integrated into the broader authentication framework to securely bootstrap the cryptographic relationship between the user device and the network. This initial exchange enables further secure processes, including attestation, validation, and encryption of sensitive data such as authentication challenges and user credentials.

Nonce means a one-time-use, cryptographically generated random or pseudo-random value included in authentication and encryption processes to ensure uniqueness and prevent replay attacks. In this invention, the nonce is a critical component of the akaChallenge generated during the EAP-AKA process. It ensures that each authentication session is unique and protects against adversaries attempting to reuse intercepted data. The nonce is included in the attested blob and encrypted communication to strengthen the security of key exchanges and validation processes.

OEM Identification Service means a service operated by the device's Original Equipment Manufacturer (OEM) to validate the authenticity and integrity of a user device during the multi-factor authentication (MFA) process. The OEM Identification Service receives attested blobs transmitted by the Cloud MFA Service, which include the device MFA public key, the Universal Integrated Circuit Card (UICC)-originated International Mobile Subscriber Identity (IMSI), the device token, and the attestation signature. Upon receiving the attested blob, the OEM Identification Service verifies the attestation signature and other included data to ensure the device has not been tampered with and originates from a legitimate OEM source. The service provides validation results to the Cloud MFA Service, which uses this information to proceed with further authentication steps, including interaction with the home operator node. By serving as a trusted intermediary in the authentication process, the OEM Identification Service enhances security and prevents unauthorized or compromised devices from accessing sensitive network resources.

Periodic Revalidation means the scheduled or event-driven repetition of the authentication process to verify the continued trustworthiness of a device within the multi-factor authentication (MFA) system. Periodic Revalidation involves the Cloud MFA Service coordinating with the device MFA service and the home operator node to repeat the Extensible Authentication Protocol-Authentication and Key Agreement (EAP-AKA) process. This includes generating new akaChallenges, validating akaResponses, and ensuring the integrity of stored cryptographic keys. Revalidation may be triggered by predefined time intervals, changes to the device environment (e.g., SIM card replacement), or security events flagged by the system. The process ensures that devices remain compliant with security standards and that any unauthorized changes or anomalies are promptly detected. Periodic Revalidation enhances the long-term reliability and resilience of the authentication framework.

Phone Number means the validated number associated with a device, retrieved from the home operator node during the authentication process. The Phone Number is derived independently of any number stored on the device and is included in the Secure Cloud Wallet alongside other authentication data. The use of a carrier-validated Phone Number enhances the integrity of the authentication process by ensuring that the number reflects the actual subscriber record maintained by the network operator, reducing the risk of spoofing or fraud.

Post-Quantum Cryptographic Algorithms means cryptographic techniques designed to resist attacks from quantum computers, which pose a threat to traditional public-key cryptographic systems. In the context of the multi-factor authentication (MFA) framework, post-quantum cryptographic algorithms are employed by the Cloud MFA Service to secure sensitive data transmissions, such as the encryption of akaChallenges, device tokens, and session keys. These algorithms may include lattice-based key encapsulation methods, such as Kyber, and other National Institute of Standards and Technology (NIST)-approved standards. By incorporating post-quantum cryptographic algorithms, the system ensures that authentication and data exchanges remain secure even against adversaries with access to quantum computational capabilities.

Private Key means the cryptographic key in a public-private key pair that is securely stored in the Trusted Execution Environment (TEE) of the user device. The Private Key is used by the device MFA service to perform cryptographic operations, such as signing the attestation signature included in the attested blob or decrypting encrypted data received from the Cloud MFA Service. The Private Key is never transmitted outside the device, ensuring its security against tampering or interception. It plays a critical role in enabling secure interactions between the device MFA service, the Cloud MFA Service, and other network entities, such as the home operator node and the OEM identification service. The confidentiality of the Private Key is foundational to the overall security of the multi-factor authentication (MFA) framework.

ProvID means a unique identifier assigned during the provisioning or key exchange process to track specific authentication or re-keying sessions. In this invention, ProvID is used by the Cloud MFA Service to associate cipher text, keys, and related metadata with a particular user device and authentication session. It facilitates efficient management of authentication workflows and ensures that session-specific data is securely handled and stored in the cloud wallet.

Public Key means the cryptographic key in a public-private key pair that is shared with external entities for secure communication and validation. In the multi-factor authentication (MFA) system, the Public Key is generated by the device MFA service and included in the attested blob transmitted to the Cloud MFA Service. The Public Key is used to verify the attestation signature, encrypt sensitive data such as akaChallenges or transaction details, and enable secure exchanges between the device and the Cloud MFA Service. The integrity and authenticity of the Public Key are validated as part of the device verification process, ensuring that it originates from a trusted source. By enabling asymmetric cryptography, the Public Key ensures that sensitive information remains secure during transmission and processing.

Push Notifications means secure messages transmitted from the Cloud MFA Service to the user device to facilitate user interaction during authentication or transaction approval processes. These notifications are encrypted with the device MFA public key to protect sensitive data, such as transaction details or authentication requests. Upon receipt, the user device decrypts the notification within the Trusted Execution Environment (TEE) and displays it to the user. The user's response is encrypted and returned to the Cloud MFA Service for validation. Push notifications ensure secure and seamless user involvement in multi-factor authentication workflows.

Quintuplet means a set of cryptographic parameters generated by the home operator node during the EAP-AKA process. The quintuplet typically includes the random number (RAND), the expected response (XRES), the ciphering key (CK), the integrity key (IK), and an authentication token (AUTN). These parameters are sent to the Cloud MFA Service and subsequently forwarded to the user device to complete the mutual authentication process. The quintuplet ensures that all necessary cryptographic elements are securely exchanged between the device and the network for session establishment and encryption.

Reactivation Request means a secure command initiated by the Cloud MFA Service to a user device when a device reactivation event is detected. The Reactivation Request triggers the device MFA service to generate a new key pair, create an updated attested blob, and re-establish mutual trust with the system by performing the Extensible Authentication Protocol-Authentication and Key Agreement (EAP-AKA) process. The request ensures that the device continues to meet security standards following changes such as SIM card replacement or firmware updates. By requiring devices to respond to Reactivation Requests, the system maintains a high level of security and prevents unauthorized devices from remaining within the authentication framework.

Re-Keying means the process of updating cryptographic keys to maintain security over time, especially following events such as UICC replacement, SIM ejection, or device reactivation. In this invention, re-keying is initiated by the Cloud MFA Service, which commands the device MFA service to generate a new key pair using the ML-KEM-1024 algorithm. The public key is encapsulated and transmitted to the Cloud MFA Service, which updates the shared key and securely stores the new key material in the cloud wallet. Re-keying ensures that prior sessions remain secure while enabling future communications to use updated cryptographic parameters.

Secure Cloud Wallet means a secure, cloud-based repository managed by the Cloud MFA Service for storing device-specific authentication data. The Secure Cloud Wallet holds validated information such as the phone number retrieved from the home operator node, the device token, the Universal Integrated Circuit Card (UICC)-originated International Mobile Subscriber Identity (IMSI), and the device MFA public key. The Secure Cloud Wallet is designed to ensure the integrity, confidentiality, and availability of the stored data through encryption and access controls. It plays a central role in enabling efficient and secure multi-factor authentication (MFA) processes by providing a reliable reference for verifying device credentials and managing session-related data.

Shared Key means a symmetric cryptographic key derived during the key exchange process between the device MFA service and the Cloud MFA Service. The Shared Key is used to encrypt and decrypt sensitive data transmitted between these entities, ensuring the confidentiality and integrity of the communication. In the context of the multi-factor authentication (MFA) framework, the Shared Key may be derived using post-quantum cryptographic algorithms, such as lattice-based methods, to resist emerging computational threats. By securing data exchanges with the Shared Key, the system protects against tampering, interception, and replay attacks, enhancing the overall robustness of the authentication process.

Shared Key Update means the process of securely replacing or refreshing a symmetric encryption key used for communication between the Cloud MFA Service and the user device. This process occurs during re-keying or when cryptographic integrity needs to be maintained. The rekey process generates a new shared key at the Cloud MFA Service as part of encapsulation and the generated cipher text is returned to the Device MFA Service. The cipher Text is decapsulated by using the MFA private key stored in the Trusted Execution Environment (TEE) to obtain the new shared key. The shared key update strengthens encryption and ensures that sensitive communications remain protected from evolving threats.

Transaction Details means specific information about a user-initiated action or request, such as a financial transaction, login attempt, or configuration change, that requires validation through the multi-factor authentication (MFA) system. Transaction Details are encrypted using the Device MFA Public Key's shared key and transmitted to the user device via a Device Push Notification for user approval. The user device decrypts the details within the Trusted Execution Environment (TEE) and provides the user with an opportunity to accept or reject the action. The validated response is then securely transmitted back to the Cloud MFA Service. By incorporating Transaction Details into the authentication process, the system ensures that users maintain control over sensitive actions, reducing the risk of unauthorized or fraudulent activity.

Universal Integrated Circuit Card (UICC)-Originated Device International Mobile Subscriber Identity (IMSI) means the unique identifier stored on the UICC and used by the multi-factor authentication (MFA) framework to authenticate the device with the carrier network. The UICC-Originated Device IMSI is included in the attested blob generated by the device MFA service and transmitted to the Cloud MFA Service. This IMSI is also provided to the home operator node during the Extensible Authentication Protocol-Authentication and Key Agreement (EAP-AKA) process, where it is used to generate akaChallenges and validate akaResponses. By relying on the UICC-Originated Device IMSI, the system ensures that the authentication process is tied to the device's identity as recognized by the carrier network, mitigating the risks associated with spoofing or tampering.

User Consent Response means a cryptographically secured acknowledgment or denial generated by the user device in response to a Device Push Notification. The User Consent Response contains information indicating whether the user has approved or rejected a specific transaction or authentication request. This response is encrypted using the device's private key and transmitted to the Cloud MFA Service for validation. Upon receiving the response, the Cloud MFA Service decrypts and verifies it, ensuring that the action reflects the user's intent. The User Consent Response provides a critical layer of user-driven security, ensuring that only authorized actions are carried out within the authentication framework.

User Device means any mobile or computing device equipped with a Universal Integrated Circuit Card (UICC) and capable of participating in the multi-factor authentication (MFA) process. The User Device hosts the device MFA service, which generates cryptographic keys, prepares attested blobs, processes authentication challenges, and communicates with the Cloud MFA Service. Examples of User Devices include smartphones, tablets, and IoT devices. By acting as a trusted endpoint in the authentication process, the User Device plays a pivotal role in ensuring the security and integrity of the MFA framework.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

What is claimed is:

1. A method of bootstrapping trust between a user device and a cloud multi-factor authentication service prior to establishment of a device-specific shared key, the method comprising:
a. generating, by the service, a time-bounded bootstrap credential that includes a public key and a bootstrap key identifier, and retaining an associated private key;
b. provisioning the bootstrap credential to the user device;
c. generating, within a trusted execution environment of the user device, a bootstrap client signing key pair;
d. performing, at the user device, a cryptographic key-establishment operation using the bootstrap credential public key to produce bootstrap key-establishment data and to derive a first bootstrap secret;
e. forming, at the user device, a bootstrap request that includes
i. the bootstrap key identifier,
ii. the bootstrap key-establishment data,
iii. a bootstrap client signing public key, and
iv. a digital signature computed using a bootstrap client signing private key over at least the bootstrap key-establishment data;
f. transmitting the bootstrap request to the service;
g. deriving, at the service, a second bootstrap secret using the service private key and the received bootstrap key-establishment data; and
h. verifying, at the service, the digital signature using the bootstrap client signing public key and, responsive to successful signature verification and secret derivation, storing the second bootstrap secret in association with the user device for protecting communication that precedes the device-specific shared key.

2. The method of claim 1, wherein the bootstrap credential is valid only within a predetermined time window identified by the bootstrap key identifier, and the service rejects a bootstrap request that references an expired time window.

3. The method of claim 1, wherein provisioning the bootstrap credential comprises obtaining the bootstrap credential from a manufacturer or bootstrap service and caching the credential on the user device.

4. The method of claim 1, further comprising encrypting, using the second bootstrap secret, at least one early message sent from the service to the user device, the at least one early message including an attested blob that contains a device public key usable to establish the device-specific shared key and other provisioning/de-provisioning request.

5. The method of claim 1, further comprising, after successful bootstrapping, establishing the device-specific shared key using a cryptographic key-establishment operation based on the device public key and thereafter replacing use of the bootstrap secret with the device-specific shared key.

6. The method of claim 1, further comprising initiating re-bootstrapping in response to a device reactivation event that includes at least one of: card replacement, module ejection, device reboot, firmware update, or rotation of the bootstrap credential.

7. The method of claim 1, wherein the cryptographic key-establishment operation comprises a post-quantum key encapsulation mechanism standardized by NIST.

8. The method of claim 7, wherein the post-quantum key encapsulation mechanism is ML-KEM and the bootstrap client signing key pair is generated according to ML-DSA.

9. The method of claim 1, wherein the bootstrap request further includes a server key identifier corresponding to a certificate of the day and the digital signature covers at least the server key identifier and the bootstrap key-establishment data.

10. The method of claim 1, further comprising binding the bootstrap client signing public key to the device by including it in an attested blob generated in the trusted execution environment.

11. The method of claim 4, wherein the at least one early message further includes a network authentication challenge and the device decrypts the challenge using the first bootstrap secret before computing a response with UICC credentials.

12. The method of claim 1, wherein the service stores the second bootstrap secret in a bootstrap wallet in association with at least a device token, an IMSI, and the bootstrap key identifier, and deletes the secret after establishment of the device-specific shared key or expiration of the bootstrap credential.

13. A system comprising a cloud multi-factor authentication service configured to:
a. generate and rotate a time-bounded bootstrap credential that includes a public key and a bootstrap key identifier while retaining an associated private key;
b. receive a bootstrap request from a user device, the request including:
i. bootstrap key-establishment data,
ii. a bootstrap client signing public key, and
iii. a digital signature;
c. derive, using the private key, a bootstrap secret from the bootstrap key-establishment data;
d. verify the digital signature using the bootstrap client signing public key; and
e. responsive to verification, store the bootstrap secret in a bootstrap wallet for encrypting early messages to the user device prior to establishment of a device-specific shared key.

14. The system of claim 13, wherein the cloud service obtains the bootstrap credential from an OEM bootstrap service and records a certificate-of-the-day identifier in the bootstrap wallet.

15. The system of claim 13, further configured to encrypt an attested blob or a network challenge with the bootstrap secret and to transmit the encrypted message to the device.

16. The system of claim 13, further configured to trigger re-bootstrapping on a device reactivation event including SIM ejection, UICC replacement, reboot, firmware update, or credential rotation.

17. The system of claim 13, wherein the bootstrap wallet associates the bootstrap secret with a device token, an IMSI, and a timestamp, and the system automatically expires the bootstrap secret upon establishment of the device-specific shared key.

18. The system of claim 13, wherein the cloud service performs decapsulation using ML-KEM and verifies the digital signature using ML-DSA.

19. A non-transitory computer-readable medium storing instructions that, when executed by one or more processors of a cloud multi-factor authentication service, cause the service to perform operations comprising the operations of claim 13.

20. The non-transitory computer-readable medium of claim 19, wherein the instructions further cause the service to encrypt early messages with the bootstrap secret and, after a device-specific shared key is established, cease use of the bootstrap secret and delete it from the bootstrap wallet.
